(19) United States
(12) Patent Application Publication
(10) Pub. No.: US 2010/0203286 A1
(43) Pub. Date: Aug. 12, 2010

(54) Structured component, in particular a shielding element in the form of a heat shield

(75) Inventors: Beate Ziak-Beyerlein, Numberg (DE); Markus Lang, Neuweiler (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ELRINGKLINGER KG, Dettingen/Erms (DE)

(21) Appl. No.: 12/308,393

(22) PCT Filed: Jun. 23, 2007
(86) PCT No.: PCT/EP2007/005554

§ 371 Date: Dec. 15, 2008

(30) Foreign Application Priority Data
Jun. 24, 2006 (DE) 10 2006 029 087.9

(51) Int. Cl. B32B 3/10

(52) U.S. Cl. 428/133

(57) ABSTRACT

The invention relates to a structured component, in particular a shielding element in the form of a heat shield, comprising a shielding body (1) with a moulded part (3) that forms a shielding surface (7), said surface at least partially surrounding a component to be shielded. The shielding body (1) has a second moulded part (5) that forms an additional shielding surface (23) and both moulded parts (3, 5) have flat dish-shaped forms that delimit at least one spacer chamber (21) with a predefinable clearance. The structured component is characterised in that the respective clearances in the spacer chamber (21), which leads to the environment, vary at least in some sections in the vicinity of the interspaced ends of the moulded parts (3, 5).

The invention relates to a structured component, in particular a shielding element in the form of a heat shield, having a shielding body which has a molded part that forms a shielding surface which at least partially surrounds the component to be shielded, the shielding body having a second molded part which forms an additional shielding surface, and both molded parts having flat shell-shaped forms that delimit at least one spacer chamber with a definable clearance.

While the generation of heat, for example, of a lean, power-optimized diesel engine on the cylinder head or crankcase can be very small, this does not apply at all to “hot zones” such as manifolds, turbochargers, catalytic converters, etc. The ever more compact construction of engines increasingly places components which are thermally “incompatible” in close proximity. Accordingly, it is necessary to protect thermal engine components relative to adjacent heat-sensitive assemblies such as sensors, fuel lines, diaphragm actuators, body parts, etc. using shielding elements such as heat shields. The situation is also exacerbated by the compact structure in that the high packing density of the assemblies narrows the cooling air flow in the engine compartment. Catalytic converters due to their phased high surface temperatures are among the heat sources which certainly can necessitate the use of protective shield barriers. One typical example of this is structural measures such as positioning of the catalytic converter close to the manifold. This building principle which is used to quickly heat up the catalytic converter and thus to reduce emissions in the cold starting phase, shifts a strong heat source into the engine compartment where numerous assemblies are crowded in a narrow space. Therefore high demands must be imposed on the heat-insulating effect of shielding elements such as heat shields. One reason for the growing importance of heat shields is also the trend toward use of thermoplastics which, due to their outstanding moldability, light weight and economic efficiency, are becoming increasingly common in the engine compartment. These materials, however, require special attention with respect to ambient temperatures at the application site.

With respect to this problem, it is prior art to make shielding elements such as heat shields in an especially complex design when they are to be used at critical application sites. Thus, for example, providing additional ventilation at especially critical sites of the shielding elements is known in order to induce intensified heat convection by means of controlled air flow, controlled in situ. Controlled air flows can be induced, for example, by use as a type of the chimney effect. Thus DE 43 00 817 A1 discloses a heat shield solution consisting of end edges of two heat shielding bodies, which edges are continuously connected on the edge side to be impermeable to media, between the two molded parts which are impermeably connected to one another in this way as shielding bodies, several spacer chambers extend with different definable clearances, which are delimited by connectors which run continuously in the form of ribs and between which in turn at least partially cone-like elevations extend which comparably to a vulcanized cone are designed to emit the collected heat in the spacer chamber using the chimney effect into the exterior. In addition to this known use of the chimney effect with the aid of air baffles, in the prior art active means are also used for this purpose by producing hot air removal, for example, by means of suction. In all these solution approaches, however, there are major added costs and often these solutions cannot be implemented as a result of the accompanying increased space requirement. Another disadvantage consists in that in ventilation by means of controlled air flow (chimney effect) there is the risk of overheating of other, normally uninvolved components by the generated hot air flow.

To avoid these disadvantages, providing a molded part which forms the shielding body in a multilayer structure is also known, on a first metallic layer which forms the actual shielding surface which faces the heat source, one or more insulating layers and/or shielding layers being provided which in turn are delimited by at least one metallic cover layer. Thus a shielding element with a multilayer structure and with a plurality of molded parts is disclosed by DE 32 15 244 A1, as a result of this multilayer structure increased production cost in terms of production engineering can be expected.

Utility Model DE 87 00 918 U1 discloses a generic structured component, in particular a shielding element in the form of a heat shield, with a shielding body which has a molded part that forms a shielding surface which at least partially encompasses the component which is to be shielded, the shielding body having a second molded part which forms an additional shielding surface, and both molded parts having flat shell-shaped forms that delimit at least one spacer chamber with definable clearances. In the known solution in turn the two molded parts are securely connected to one another on the end side in all directions in a media-tight, in particular fluid-tight manner, and favorable convective heat dissipation is achieved via a complex topography relative to the shielding body of the molded parts, and the complex structure which has been achieved in this way with a plurality of infinitesimally produced box-shaped component spaces also effects very good sound-absorbing action; here as a result of the box-shaped projections the already described unwanted chimney effect can also occur with the possibility of partial overheating and otherwise the known heat shield solution is structurally complex in implementation.

With respect to this prior art the object of the invention is to make available a structured component, in particular a shielding element in the form of a heat shield which can be produced easily and economically and which is characterized by an especially good insulating effect relative to the action of heat and/or solid-borne noise and in this respect also fully meets the requirements to be imposed in regions under high thermal load.

According to the invention this object is achieved by a structured component which has the features of claim 1 in its entirety.

Accordingly, the particularity of the invention consists in that according to the characterizing part of claim 1 at least partially in the region of the ends of the molded parts which are spaced apart from one another, the respective clearance of the spacer chamber which ends in the vicinity of the structured component is different. While in the prior art a molded part which forms the shielding body is made in several layers by a sandwich construction if necessary, i.e., when an especially good insulating effect is required in thermally highly loaded zones, the basic principle of the invention conversely consists in that, in addition to doubling of the simply configured molded parts, that is, for example, formed from a single-layer metal sheet, between which there is an air space as the spacer chamber, the required intensified insulating effect is achieved in that based on the different clearances in the end regions which are continuously opened relative to the exterior and which are connected to one another to conduct air to a limited extent through the molded parts, a type of ventilation effect is achieved and good heat-dissipating circulation between the molded parts as shielding bodies of the heat shield occurs without, however, in this way an unwanted chimney effect with damaging overheating being able to occur.

It is surprising to one with average skill in the art in the area of heat shield technology that he obtains a ventilation characteristic as in a chimney as a result of the different clearances relative to the free opening cross sections limited by the molded parts of the structured component, but without the otherwise accompanying adverse overheating phenomena having to be tolerated, as occur in heat shield solutions in which the respective molded parts on the edge side are securely joined flush to one another in a media-tight manner.

Depending on the circumstances at the application site, there can be doubling over the entire surface, the shielding surface of the second molded part extending essentially over the entire surface area of the shielding surface of the first molded part, or, alternatively, the arrangement can be such that the shielding surface of the second molded part extends merely over an especially highly loaded partial surface region of the shielding surface of the first molded part.

Thus, based on the invention a partial or stronger shielding action over the entire surface can be achieved by means of a structured component which can be produced cost-effectively and in an automated production process.

An especially good insulating effect in particularly critical, highly loaded regions can be ensured by an embodiment in which the clearance of the spacer chamber measured in the direction normal to the shielding surfaces has different dimensions in different surface regions. In this way, between the molded parts an air cushion of locally different thickness is formed so that a localized varied insulating effect can be achieved.

In advantageous embodiments the clearances of the spacer chamber can be in the range from 2 to 12 mm, preferably from 2.5 to 5 mm.

Preferably the first molded part which forms the larger shielding surface is the molded part which is nearer the component to be shielded.

In one advantageous embodiment which is especially well-suited as relatively large-area shielding on the exhaust manifold, the first molded part can have the form of a flat shell with a longitudinal extension, with two parallel side edges which run in the longitudinal direction, one end edge which connects them on one end, and with wall parts opposite this end edge which are preferably essentially perpendicular to the bottom surface of the shell. In this shell construction which is made in the form of the breast plate of a suit of armor, the second molded part which is farther away from the heat source can continuously overlap the first molded part from side edge to side edge.

Depending on whether there is doubling over the entire surface or partial doubling of the shielding surfaces, the longitudinal extension of the second molded part can be equal to the longitudinal extension of the first molded part or less than that of the first molded part, and in the latter case the second molded part can be attached to the first molded part such that it lies exposed in the region of the end edge and of the end opposite thereof.

In this instance, the arrangement has preferably been made such that the clearance of the spacer chamber has the greatest value on that end which is adjacent to the end of the first molded part which has the vertical wall parts. In this configuration the risk of the unwanted chimney effect by the presence of wall parts which are perpendicular to the bottom surface of the shell is further reduced, in particular when the spacer chamber is made such that its clearance decreases in the direction to its end which is adjacent to the end edge of the first molded part and has the smallest value on this end. In this instance the spacer chamber ends in a narrow, end-side gap.

In order to enable access for auxiliary devices to the shielded components, the first and second molded part can have openings which are flush with one another at the locations under consideration.

The invention is detailed below using one embodiment shown in the drawings.

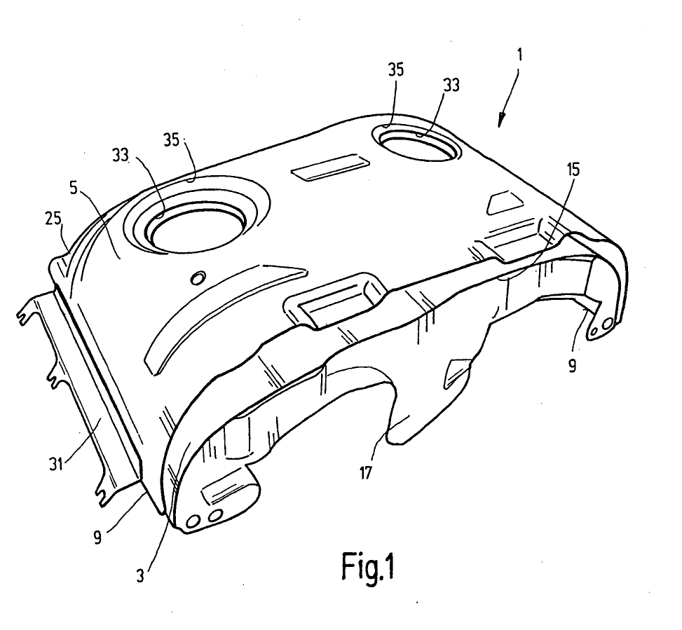

FIG. 1 shows a perspective oblique view of one embodiment of the structured component according to the invention in the form of a heat shield for shielding of the exhaust manifold;

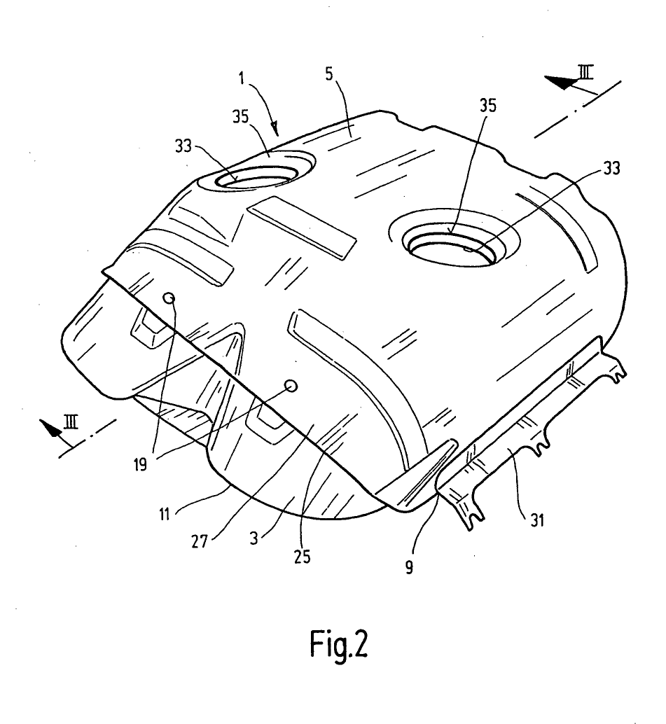

FIG. 2 shows a perspective oblique view of the embodiment corresponding to FIG. 1, but looking at the end edge which is opposite the end shown in FIG. 1, and

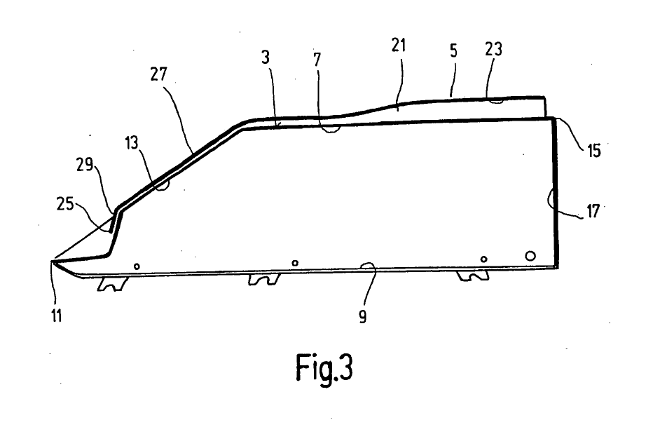

FIG. 3 shows a cross section according to line III-III in FIG. 2.

The figures show one embodiment of the structured component according to the invention in the form of a heat shield with a shielding body which is designated as a whole as 1 and which is formed from a first molded part 3 and a second molded part 5. Both molded parts 3 and 5 are formed from a high-grade steel sheet by pressing. In particular, they are made of materials or a multilayer material composite, as is known in the trade by the name “Elrotherm ML”. As a comparison of FIGS. 1 and 2 with the section from FIG. 3 shows, the first molded part 3 largely has the shape of a comparatively flat shell with a bottom surface, see FIG. 3, which forms a shielding surface 7 which faces a heat source which is not shown and which is surrounded by the shell shape.

The side edges 9 which form the side boundary of the shell shape and which extend in the longitudinal direction of the shell shape run in a straight line and parallel to one another. The ends of the side edges 9 which are located on the left side in FIG. 3 are connected to one another by a bottom section 13 which runs obliquely toward an end edge 11. On the opposite end 15 of the molded part 3 the shell shape is partially terminated by wall parts 17 which run perpendicular to the bottom surface and which, see FIG. 1, are irregularly shaped to match the bordering components.

The second molded part 5 is securely joined to the first molded part 3 by suitable riveting at fastening sites at which spacer humps which are not detailed are stamped, and of which only the rivet sites 19 are indicated in FIG. 2, such that between the first molded part 3 and the second molded part 5 a spacer chamber 21 (FIG. 3) is formed. The second molded part 5 thus forms a second shielding surface 23 which runs at a distance from the shielding surface 7 of the first molded part 3 formed by the bottom surface, with the formation of an interposed air space.

As is especially apparent from FIG. 3, the clearance of the spacer chamber 21 which is formed toward the shielding surfaces 7 and 23 has dimensions that differ as a function of the location. To be more specific, the spacer chamber 21 on the starting region of the second molded part 5 adjacent to the end 15 has the largest value. This starting region of the second molded part 5, relative to the longitudinal direction, is located at a distance from the outer end 15 of the first molded part 3, i.e., the second molded part 5 has a shorter length than the first molded part 3. As is to be seen from FIGS. 2 and 3, the second molded part 5 with its opposite end 25 also ends at a distance from the end edge 11 of the first molded part 3. As can likewise be seen from FIG. 3, the clearance of the spacer chamber 21 diminishes proceeding from the largest value on the end which is on the right side in FIG. 3, along the section of the bottom part which runs parallel to the side edges, and then runs with a uniform width along a tilted section 27 and a more highly angled end section 29 as far as the end 25, the clearance in sections 27 and 29 and on the end 25 having the smallest value.

As is to be seen from FIGS. 1 and 2, the second molded part 5 extends over the entire width of the first molded part 3 from side edge 9 to side edge 9. On the latter the two molded parts 3 and 5 are welded or riveted to one another and to one fastening strip 31 each. As in particular the cross section as shown in FIG. 3 illustrates, viewed in the direction of looking at the indicated figure, the two molded parts 3, 5, in the left region along a bevel, border an essentially constant ventilation gap as the smallest open gap width, which undergoes transition into a widening horizontal region, the horizontal horizon line in the illustrated base position of the shielding component as far as its right end region maintaining this horizontal boundary surface, conversely the overlying molded part 5 widening first in the transition region in the manner of a bag in order to then undergo transition with a smaller rise into the end with the largest open gap width for the spacer chamber 21.

This shape progression with spacer chamber regions which viewed in cross section run continuously over a specific distance and then differently has proven favorable for the desired ventilation with optimized heat dissipation. The respective course of the gap line viewed in cross section, with different clearances of the spacer chamber which for this purpose, as shown, ends in the exterior to carry media and air, has also proven extremely favorable if it is a matter of insulation and absorption of unwanted sound (noise). To support the indicated transition effect, as already described, the two molded parts are securely joined to one another in a media-tight manner along their parallel running longitudinal edges 9.

FIGS. 1 and 2 also show that in the two molded parts 3, 5 openings 33 and 35 are made flush with one another and enable access to the exhaust manifold which is located within the shell for auxiliary devices, such as lambda probes or the like.

As already mentioned, in the embodiment described here, the second molded part 5 in conjunction with the first molded part 3 forms almost a doubling over the entire surface of the shielding surfaces 7 and 23 which face the component to be shielded. For localized thermal loading only which is especially high, the second molded part 5 could be made such that it extends only over the region of the partial surface of interest, in which a corresponding spacer chamber is formed.

1. A structured component, in particular a shielding element in the form of a heat shield, having a shielding body (1) which has a molded part (3) that forms a shielding surface (7) which at least partially surrounds a component to be shielded, the shielding body (1) having a second molded part (5) which forms another shielding surface (23), both molded parts (3, 5) having flat shell-shaped forms that delimit at least one spacer chamber (21) with definable clearances, characterized in that at least partially in the region of the ends of the molded parts (3, 5) which are spaced apart from one another, the respective clearance of the spacer chamber (21), which for this purpose ends in the vicinity of the structured component, is different.

2. The structured component according to claim 1, characterized in that the shielding surface (23) of the second molded part (5) extends essentially over the entire surface area of the shielding surface (7) of the first molded part (3).

3. The structured component according to claim 1, characterized in that the shielding surface (23) of the second molded part (5) extends over an especially highly loaded partial surface region of the shielding surface (7) of the first molded part (3).

4. The structured component according to claim 1, characterized in that the clearance of the spacer chamber (21) measured in the direction normal to the shielding surfaces (7, 23) has different dimensions in different surface regions.

5. The structured component according to claim 4, characterized in that the clearances of the spacer chamber (21) are in the range from 2.5 to 5 mm.

6. The structured component according to claim 1, characterized in that the first molded part (3) which forms the larger shielding surface (7) is the molded part which is nearer the component to be shielded.

7. The structured component according to claim 1, characterized in that the first molded part (3) in the form of a flat shell has a longitudinal extension with two parallel side edges (9) which run in the longitudinal direction, one end edge (11) which connects them on one end, and with wall parts (17) arranged opposite this end edge.

8. The structured component according to claim 7, characterized in that the wall parts (17) are essentially perpendicular to the bottom surface of the shell in the form of the molded part (3).

9. The structured component according to claim 7, characterized in that the second molded part (5) continuously overlaps the first molded part (3) from side edge (9) to side edge (9).

10. The structured component according to claim 7, characterized in that the longitudinal extension of the second molded part (5) is less than that of the first molded part (3), and that the second molded part (5) is attached to the first molded part (3) such that it lies exposed in the region of the end edge (11) and of the end (15) opposite it.

11. The structured component according to claim 7, characterized in that the clearance of the spacer chamber (21) has the greatest value on that end which is adjacent to the end (15) of the first molded part (3), which end has vertical wall parts (17).

12. The structured component according to claim 11, characterized in that the clearance of the spacer chamber (21) decreases in the direction to its end which is adjacent to the end edge (11) of the first molded part (3) and generally has the smallest value on this end.

13. The structured component according to claim 1, characterized in that the first (3) and second molded part (3) have openings (33 and 35) which are made flush with one another for forming access for auxiliary devices, for example, lambda probes, to the component which is to be shielded.
